(19) United States
(12) Patent Application Publication
(10) Pub. No.: US 2021/0269704 A1
(43) Pub. Date: Sep. 2, 2021

(54) STIMULATION FLUIDS CONTAINING METAL SILICATES

(71) Applicant: HALLIBURTON ENERGY SERVICES, INC., Houston, TX (US)

(72) Inventors: Tatyana KHAMATNUROVA, Houston, TX (US); Philip NGUYEN, Houston, TX (US); Janette Cortez MONTALVO, Houston, TX (US)

(73) Assignee: HALLIBURTON ENERGY SERVICES, INC., Houston, TX (US)

(21) Appl. No.: 16/806,680

(22) Filed: Mar. 2, 2020

(51) Int. Cl. C09K 8/66; C09K 8/68; C09K 8/80

(52) U.S. Cl. CPC C09K 8/665; C09K 8/80; C09K 8/68

(57) ABSTRACT

Fracturing fluids and acidizing fluids used in wellbore stimulation operations can include a metal silicate having a molar ratio of SiO₂:M₂O of 2:1 or above, wherein M is an alkali metal atom or an alkaline earth metal atom. The metal silicate can increase the viscosity of the stimulation fluids and slickwater stimulation fluids.

### TECHNICAL FIELD

Enhanced recovery of oil or gas from a subterranean formation can utilize stimulation techniques. Stimulation techniques can include fracturing operations and acidizing operations. A fracturing fluid and acidizing fluid can include a variety of additives to provide desirable properties to the stimulation fluids.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a diagram illustrating a stimulation system according to certain embodiments.

FIG. 2 is a diagram illustrating a well system in which a fracturing stimulation operation can be performed.

FIG. 3 is a bar graph of viscosity (cP) versus concentration (gpt) of a metal silicate in a simulated slickwater fluid at different shear rates.

FIG. 4 is a bar graph of viscosity (cP) versus different test fluids with and without a metal silicate.

### DETAILED DESCRIPTION

Oil and gas hydrocarbons are naturally occurring in some subterranean formations. In the oil and gas industry, a subterranean formation containing oil and/or gas is referred to as a reservoir. A reservoir can be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from a reservoir is called a reservoir fluid.

As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A heterogeneous fluid can be: a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. As used herein, the term “base fluid” means the solvent of a solution or the continuous phase of a heterogeneous fluid and is the liquid that is in the greatest percentage by volume of a treatment fluid.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within approximately 100 feet radially of the wellbore. As used herein, “into a subterranean formation” means and includes into any portion of the well, including into the wellbore, into the near-wellbore region via the wellbore, or into the subterranean formation via the wellbore.

A portion of a wellbore can be an open hole or cased hole. In an open-hole wellbore portion, a tubing string can be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During wellbore operations, it is common to introduce a treatment fluid into the well. Examples of common treatment fluids include, but are not limited to, drilling fluids, spacer fluids, completion fluids, and stimulation fluids. As used herein, a treatment fluid is a fluid designed and prepared to resolve a specific condition of a well or subterranean formation, such as for stimulation, isolation, gravel packing, or control of gas or water coning. The term “treatment fluid” refers to the specific composition of the fluid as it is being introduced into a well. The word “treatment” in the term “treatment fluid” does not necessarily imply any particular action by the fluid.

Stimulation treatment fluids can include fracturing fluids and acidizing fluids. A fracturing fluid is pumped using a frac pump at a sufficiently high flow rate and high pressure into the wellbore and into the subterranean formation to create or enhance a fracture in the subterranean formation. Creating a fracture means making a new fracture in the formation. Enhancing a fracture means enlarging a pre-existing fracture in the formation. To fracture a subterranean formation typically requires hundreds of thousands of gallons of fracturing fluid. Further, it is often desirable to fracture at more than one downhole location. The fracturing fluid is usually water or water-based for various reasons, including the ready availability of water and the relatively low cost of water compared to other liquids. It is not uncommon to include produced water in the fracturing fluid in addition to or instead of freshwater. Produced water generally includes a high concentration of total dissolved solids (TDS), for example concentrations ranging from 500 to 300,000 milligrams per liter “mg/L”. Total dissolved solids are the total amount of mobile charged ions, including minerals, salts, or metals dissolved in a given volume of water, expressed in units of milligrams per liter of water (mg/L).

The newly-created or enhanced fracture may tend to close together after pumping of the fracturing fluid has stopped. To prevent the fracture from closing, a material can be placed in the fracture to keep the fracture propped open. A material used for this purpose is often referred to as proppant. The proppant is in the form of solid particles, which are generally suspended in the fracturing fluid, carried down hole, and deposited in the fracture as a proppant pack. The proppant pack props the fracture in an open position while allowing fluid flow through the permeability of the pack.

In order to carry the proppant to the desired location within the fracture, the fracturing fluid requires a specific viscosity. If the viscosity of the fracturing fluid is too low, then the proppant could prematurely screen out of the fracture and remain in the near-wellbore region instead of penetrating into the entirety of the fracture. This could result in a portion of the fracture closing, which would reduce the volume of produced reservoir fluids. Conversely, if the viscosity is too high, then the fracturing fluid may be too viscous to pump at the necessary flow rate and pressure. Therefore, an additive is generally included in a fracturing fluid in order to impart the desired viscosity to the fluid.

Viscosity is the resistance of a fluid to flow, defined as the ratio of shear stress to shear rate. The unit of viscosity is Poise, equivalent to dyne-sec/cm². The unit centipoise (“cP”), which is 1/100 Poise, is usually used with regard to well treatment fluids. Viscosity must have a stated or an understood shear rate in order to be meaningful. Measurement temperature also must be stated or understood. As used herein, if not otherwise specifically stated, the viscosity of a fluid is measured with an Anton Paar Rheometer 702 viscometer using a shear sweep at 25° C. (77° F.). Shear sweep is a testing procedure wherein the viscometer measures the viscosity across a wide range of shear rates. The data can be analyzed by using a calculation to determine the viscosity of the sample at a specific shear rate, for example, at a shear rate of 40 s⁻¹.

Some fracturing fluids are pumped at flow rates less than 60 barrels per minute “bpm,” while other fracturing fluids are pumped at flow rates greater than 60 bpm, commonly referred to as slickwater fracturing. Fracturing fluids pumped at the lower flow rates generally include cross-linked polymers, such as cross-linked guar, in order to increase the viscosity. One important chemical additive for slickwater-fracturing fluids is a friction reducer. The high pump rates for slickwater treatments (often 60-100 bpm) necessitate the action of friction reducers to reduce friction pressures by up to 70%. Common friction reducers include non-cross-linked polymers, such as polyacrylamide derivatives and copolymers added to the base fluid of the slickwater.

A polymer is a molecule composed of repeating units, typically connected by covalent chemical bonds. A polymer is formed from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain pendant functional groups connected to the backbone at various locations along the backbone. Polymer nomenclature is generally based upon the type of monomer residues comprising the polymer. A polymer formed from one type of monomer residue is called a homopolymer. A polymer formed from two or more different types of monomer residues is called a copolymer. The number of repeating units of a polymer is referred to as the chain length of the polymer. The number of repeating units of a polymer can range from approximately 11 to greater than 10,000. In a copolymer, the repeating units from each of the monomer residues can be arranged in various manners along the polymer chain. For example, the repeating units can be random, alternating, periodic, or block. The conditions of the polymerization reaction can be adjusted to help control the average number of repeating units (the average chain length) of the polymer. Polymer molecules can be cross-linked. As used herein, a “cross-link” and all grammatical variations thereof is a bond between two or more polymer molecules. Cross-linked polymer molecules can form a polymer network.

A polymer has an average molecular weight, which is directly related to the average chain length of the polymer. The average molecular weight of a polymer has an impact on some of the physical characteristics of a polymer, for example, its solubility and its dispersibility. For a copolymer, each of the monomers will be repeated a certain number of times (number of repeating units). The average molecular weight (M_{w}) for a copolymer can be expressed as follows:

M_{w}=ΣwₓMₓ

where wₓ is the weight fraction of molecules whose weight is Mₓ.

However, when a fracturing fluid or slickwater fracturing fluid contains high TDS concentrations, then the fracturing fluid can lose viscosity to an undesirable level for proper proppant placement. For example and without being limited by theory, it is believed that the high salt content in some fracturing fluids can cause the molecular structure of non-cross-linked friction reducers to coil, which causes the decreased viscosity. In order to overcome this unacceptable reduction in viscosity, some attempts to solve this problem have included: increasing the concentration of the non-cross-linked friction reducer; utilizing newly developed polymers; or utilizing “hybrid” polymers (e.g., a guar polyacrylamide). Unfortunately, most of the attempts to solve this problem significantly increase the cost of the treatment fluid. Thus, there is a need for improved additives in fracturing fluids that are lower in cost and effective to impart desirable properties to the fluids.

Acidizing fluids are also used in stimulation techniques to improve production from a subterranean formation. Acidizing treatments can include: acid washing wherein an acid is used to clean tubing strings and wellbore equipment from scale, rust, or other undesirables; matrix acidizing wherein an acid or a delayed acid is used to degrade any filtercake formation, sediments, or mud solids on the wall of the wellbore, on wellbore equipment, and within the pores of the subterranean formation; and fracture acidizing wherein an acid or delayed acid is pumped into a well above the fracture pressure of the subterranean formation to fracture and clean the formation. As used herein, a “delayed acid” means any molecule or ion that cannot function as an acid (i.e., donate a proton) at the time the fluid is introduced into the well, but rather functions as an acid at some period of time after introduction into the well. It is to be understood that “introduction” means at the wellhead. Accordingly, a delayed acid can be, for example, encapsulated such that the encapsulating material dissolves or erodes after a desired period of time to release the acid, contained within a micro-emulsion such that the micro-emulsion is broken after a desired period of time to release the acid, or an acid precursor. As used herein, an “acid precursor” is an organic compound (e.g., an ester of orthoformate or amide) that hydrolyzes and forms an acid in the presence of water. The acid precursor hydrolyzes when in contact with a water-based wellbore fluid to form an acid. A delayed acid can also be part of a delayed acid breaker system.

Acidizing fluids contain additives to impart desirable properties to the fluid. Some additives include, but are not limited to, surfactants and corrosion inhibitors. A surfactant can lower the interfacial tension between two liquids or between a solid and a liquid. As such, a surfactant can be used to reduce the surface tension between the solids of a subterranean formation and a treatment fluid. A surfactant can also be used to change the wettability of the surface of solids of a formation. Wettability means the preference of a surface to be in contact with one liquid or gas rather than another. Accordingly, “oil-wet” means the preference of a surface to be in contact with an oil phase rather than a water phase or gas phase, and “water-wet” means the preference of a surface to be in contact with a water phase rather than an oil phase or gas phase. A surfactant can be used to change the wettability of the surface of the solids from being oil-wet to being water-wet. These changes can enhance imbibition causing the treatment fluid to penetrate farther into the formation, thereby degrading or dissolving more filtercake formation, sediments, or mud solids, which increases porosity of the formation and oil or gas production. Corrosion inhibitors can be used to reduce or eliminate the harmful corrosion of wellbore equipment that acids can cause. Some of these additives can be quite costly. Thus, there is a need for improved additives for acidizing fluids that are lower in cost and possess desirable functionalities.

A fracturing fluid can include: a base fluid, wherein the base fluid comprises water; proppant; a friction reducer; and a metal silicate having a molar ratio of SiO₂:M₂O of 2:1 or above, wherein M is an alkali metal atom or an alkaline earth metal atom.

An acidizing fluid can include: a base fluid, wherein the base fluid comprises water; an acid or a delayed acid; and a metal silicate having a molar ratio of SiO₂:M₂O of 2:1 or above, wherein M is an alkali metal atom or an alkaline earth metal atom.

Methods of performing a stimulation operation on a subterranean formation can include introducing the fracturing fluid or the acidizing fluid into the subterranean formation.

It is to be understood that the discussion of any of the embodiments regarding the fracturing fluid (“frac fluid”) and the acidizing fluid or any ingredient in the frac fluid and acidizing fluid is intended to apply to all of the method and composition embodiments without the need to repeat the various embodiments throughout. Any reference to the unit “gallons” means U.S. gallons.

The fracturing fluid and the acidizing fluid (collectively, the “stimulation fluids”) includes a base fluid. The base fluid can be the solvent or the continuous phase of the stimulation fluids. The base fluid according to any of the stimulation fluids can include water. The water according to any embodiment can be selected from the group consisting of freshwater, brackish water, saltwater, produced water, and any combination thereof. The base fluid can include dissolved solids, for example, water-soluble salts. The salt can be selected from the group consisting of sodium chloride, calcium chloride, calcium bromide, potassium chloride, potassium bromide, magnesium chloride, sodium bromide, cesium formate, cesium acetate, and any combination thereof. The total dissolved solids in the base fluid according to any of the stimulation fluids can be in the range from 500 to 300,000 mg/L of the water.

The fracturing fluid can also include proppant. In a fracture acidizing operation, the acidizing fluid can also include proppant. As used herein, the term “proppant” means a multitude of solid, insoluble particles. The proppant can be naturally occurring, such as sand, or synthetic, such as a high-strength ceramic. Suitable proppant materials include, but are not limited to, sand (silica), walnut shells, sintered bauxite, glass beads, plastics, nylons, resins, other synthetic materials, and ceramic materials. Mixtures of different types of proppant can be used as well. The concentration of proppant in a fracturing fluid can be in any concentration known in the art, and preferably will be in the range of from about 0.01 kilograms to about 3 kilograms of proppant per liter of the base fluid (about 0.1 lb/gal to about 25 lb/gal). The size, sphericity, and strength of the proppant can be selected based on the actual subterranean formation conditions to be encountered during the fracturing operation.

Any of the stimulation fluids can be pumped at a desired flow rate and pressure. The fracturing fluid is preferably pumped at a flow rate and pressure that is above the fracture pressure of the subterranean formation in order to create or enhance one or more fractures. In an embodiment, the fracturing fluid can be pumped at a flow rate of less than 60 barrels per minute “bpm.” The fracturing fluid can include a cross-linked polymer. The cross-linked polymer can be a viscosifying agent or gelling agent. The cross-linked polymer can be selected from guar, xanthan, and combinations thereof. The cross-linked polymer can be in a concentration in the range of 10 to 120 “pptg” parts per thousand gallons of the base fluid or 1.2 g/L to 14.4 g/L.

In some embodiments, the frac fluid can be slickwater and pumped at high flow rates greater than 60 bpm. The slickwater fracturing fluid can include the friction reducer. The friction reducer can be a non-cross-linked polymer. The non-cross-linked polymer can be selected from polyacrylamide, derivatives of polyacrylamide, and copolymers of polyacrylamide (for example, polyacrylamide copolyacrylic acid), and other water soluble polymers, such as guar gum, guar gum derivatives, polysaccharides and derivatives, and cellulose derivatives. Preferably, the non-cross-linked polymeric friction reducer is polyacrylamide. The non-cross-linked polymeric friction reducer can be in a concentration in the range of 0.2 to 10 gallons per thousand gallons of the base fluid “gpt”, or 1 to 8 gpt.

In some embodiments, the acidizing fluid is part of a fracture acidizing operation and the acidizing fluid is pumped at a flow rate and pressure that is above the fracture pressure of the subterranean formation. In some other embodiments, the acidizing fluid is part of an acid washing or matrix acidizing operation and the acidizing fluid is pumped at a flow rate and pressure that is below the fracture pressure of the subterranean formation.

The stimulation fluids include the metal silicate. A metal silicate is a generic name for a compound containing a metal cation and a silicate anion. The silicate anion consists of silicon and oxygen. Silicates can include orthosilicate, metasilicate, and pyrosilicate. The metal silicate can have a molar ratio of SiO₂:M₂O of 2:1 or above, wherein M is an alkali metal atom or an alkaline earth metal atom. The metal silicate can have a molar ratio of SiO₂:M₂O in the range of 2:1 to 2.85:1. This molar ratio can be used when an alkaline metal silicate is desirable to impart specific properties to the metal silicate or stimulation fluid. A neutral metal silicate can have a molar ratio of SiO₂:M₂O in the range of 2.85:1 to 3.75:1. Alkali metal atoms are found in Group I of the Periodic table and include lithium, sodium, potassium, rubidium, caesium, and francium. Alkaline earth metal atoms are found in Group II of the Periodic table and include beryllium, magnesium, calcium, strontium, barium, and radium. In some embodiments, M is an alkali metal atom. In some preferred embodiments, M is sodium or potassium. In some embodiments, the metal silicate is sodium metasilicate, sodium orthosilicate, potassium metasilicate, or potassium orthosilicate. Use of sodium metasilicate can be advantageous, for example, due to the low cost of sodium metasilicate. In any embodiment, the metal silicate can be soluble in water. As used herein, “soluble” means that at least 5% of the metal silicate by weight of the water dissolves at a temperature of 71° F. (21.7° C.) and a pressure of 1 atm.

Silicate anions are often large “polymeric” molecules (sometimes referred to as oligomers of polymers) with an extensive variety of structures, including chains and rings (as in polymeric metasilicate [SiO₃²⁻]ₙ), and double chains or sheets (as in [Si₂O₅²⁻]ₙ). These large “polymeric” anions can become entangled and form an entanglement network with pendant groups on other polymers (e.g., a cross-linked or non-cross-linked polymer additive). The formation of an entanglement network can increase the overall viscosity of a treatment fluid.

The metal silicate can be included in any of the stimulation fluids in a liquid form. In the liquid form, the metal silicate is dissolved in an aqueous liquid. The solubility of the metal silicate can vary and be up to 35% by weight of the water. The concentration of the liquid form metal silicate can be in the range of 0.01 to 20 gpt, preferably 0.1 to 8 gpt.

The metal silicate can also be included in any of the stimulation fluids in a dry, solid form. In the dry, solid form, the metal silicate concentration can be in the range of 0.01% weight by weight of the base fluid to 10% w/w, preferably 0.1% to 2% w/w.

Any of the stimulation fluids can have a viscosity less than 3 cP prior to the addition of the metal silicate. According to any embodiment, after addition of the metal silicate, the stimulation fluids have a viscosity greater than 10 cP. The addition of the metal silicate can increase the viscosity of the stimulation fluids at least three times compared to a fracturing fluid without the metal silicate. For a frac fluid containing a non-cross-linked polymeric friction reducer, without being limited by theory, it is believed that the metal silicate creates a synergistic effect with the friction reducer whereby the viscosity of the fracturing fluid is increased due to the formation of an entanglement network between the friction reducer and the metal silicate.

Any of the stimulation fluids can have a viscosity of at least 8 cP, a viscosity in the range of 8 cP to 50 cP, or a viscosity in the range of 10 cP to 20 cP. In some embodiments, the base fluid has a total dissolved solids concentration of at least 10,000 mg/L of water, and the stimulation fluids have a viscosity of at least 8 cP, a viscosity in the range of 8 cP to 50 cP, or a viscosity in the range of 10 cP to 20 cP.

The fracturing fluids can further include other additives. The other additives can include, but are not limited to, surfactants, tackifying agent, resins, curable resins, curing agents for a curable resin, oxygen scavengers, alcohols, scale inhibitors, fluid-loss additives, oxidizers, bactericides, and biocides. Because the metal silicate is a corrosion inhibitor, it may not be necessary to add an additional corrosion inhibitor to any of the fracturing fluids.

Acidizing fluids are provided for performing an acidizing treatment on a subterranean formation. The acidizing treatment can be acid washing, matrix acidizing, or fracture acidizing. The acidizing fluids can clean wellbore equipment of scale, buildup, etc.; or degrade a filtercake, sediments, or mud solids on the wall of the wellbore, on wellbore equipment, and within the pores of the subterranean formation; or acid fracture a subterranean formation.

The acidizing fluid includes an acid or a delayed acid. The delayed acid can be part of a delayed acid breaker system. Common acids, encapsulated acids, or emulsified acids can be selected from, but are not limited to, hydrochloric acid, hydrofluoric acid, organic acids such as acetic acid or formic acid, N-(phosphonomethyl)iminodiacetic acid; a salt of N-(phosphonomethyl)iminodiacetic acid; a phosphonic acid; a salt of a phosphonic acid; and any combination thereof. A delayed acid precursor can be by way of one non-limiting example, an ester of a carboxylic acid. The carboxylic acid can be, without limitation, formic acid, lactic acid, acetic acid, propionic acid, tartaric acid, or any aliphatic or aromatic acid. The acid generating inert agent used to generate the hydrofluoric acid solution is a sulfonate ester and the acid generating activator used to generate the hydrofluoric acid solution is a fluoride salt, wherein the sulfonate ester is selected from the group consisting of a methyl p-toluenesulfonate; an ethyl p-toluenesulfonate; a methyl o-toluenesulfonate; an ethyl o-toluenesulfonate; a methyl m-toluenesulfonate; an ethyl m-toluenesulfonate; a methyl methanesulfonate; an ethyl methanesulfonate; an any combinations thereof, and wherein the fluoride salt is selected from the group consisting of an ammonium fluoride; an ammonium bifluoride; a potassium fluoride; a potassium bifluoride; a sodium fluoride; a sodium bifluoride; a lithium fluoride; a lithium bifluoride; a rubidium fluoride; a rubidium bifluoride; a cesium fluoride; a cesium bifluoride; and any combinations thereof. The acid generating inert agent used to generate the hydrochloric acid solution is a sulfonate ester and the acid generating activator used to generate the hydrochloric acid solution is a chloride salt, wherein the sulfonate ester is selected from the group consisting of a methyl p-toluenesulfonate; an ethyl p-toluenesulfonate; a methyl o-toluenesulfonate; an ethyl o-toluenesulfonate; a methyl m-toluenesulfonate; an ethyl m-toluenesulfonate; a methyl methanesulfonate; an ethyl methanesulfonate; an any combinations thereof, and wherein the chloride salt is selected from the group consisting of an ammonium chloride; a potassium chloride; a sodium chloride; a lithium chloride; a cesium chloride; and any combinations thereof.

The volume of acid used in any of the acidizing embodiments can range from 10 to 500 gallons per foot of the formation being treated. The concentration of the acid or the delayed acid can be in the range of 1% to 35% weight by weight of the base fluid “w/w,” alternatively 5% to 25% w/w.

Any of the acidizing fluids can include a surfactant. The surfactant can be a non-ionic or anionic surfactant. The surfactant can also be a combination of different types of surfactants as part of a surfactant package. Any of the surfactants can be included in the acidizing fluid as a micro-emulsion. The surfactant can be in a concentration in the range of 0.2 to 1.5 gpt, alternatively 0.5 to 1 gpt.

Any of the acidizing fluids can also include other additives. The other additives can include, but are not limited to, iron-control agents such as iron-complexing agents or iron-reducing agents, chelating agents, mutual solvents, alcohols, clay stabilizers, acid diverters, calcium sulfate inhibitors, and gelling agents. One significant advantage to inclusion of the metal silicate is that it is a corrosion inhibitor and also lowers interfacial tension. Accordingly, separate corrosion inhibitors and/or surfactants, which are commonly included in acidizing fluids, may not need to be added.

An embodiment of the present disclosure is a method of fracturing a subterranean formation comprising: introducing a fracturing fluid into the subterranean formation, wherein the fracturing fluid comprises: a base fluid, wherein the base fluid comprises water; proppant; a friction reducer; and a metal silicate having a molar ratio of SiO₂:M₂O of 2:1 or above, wherein M is an alkali metal atom or an alkaline earth metal atom; and creating or enhancing one or more fractures in the subterranean formation. Optionally, the method further comprises a base fluid having a total dissolved solids concentration in the range from 500 mg/L to 300,000 mg/L. Optionally, the method further comprises the friction reducer comprising a non-cross-linked polymer. Optionally, the method further comprises the non-cross-linked polymer selected from the group consisting of polyacrylamide, derivatives of polyacrylamide, copolymers of polyacrylamide, and combinations thereof. Optionally, the method further comprises the friction reducer in a concentration in the range of 0.1 gpt to 10 gpt. Optionally, the method further comprises the fracturing fluid further comprising a gelling agent, and wherein the gelling agent comprises a cross-linked polymer. Optionally, the method further comprises the cross-linked polymer selected from the group consisting of guar, guar gum derivatives, polysaccharides and derivatives, cellulose derivatives, and combinations thereof. Optionally, the method further comprises the fracturing fluid having a viscosity greater than 10 cP at a shear rate of 40 s⁻¹ and a temperature of 77° F. Optionally, the method further comprises the metal silicate is added to the base fluid in a liquid form, and wherein the metal silicate is in a concentration in the range of 0.01 to 20 gallons per thousand gallons of the base fluid. Optionally, the method further comprises the metal silicate is added to the base fluid in a dry, solid form, and wherein the metal silicate is in a concentration in the range of 0.01% weight by weight of the base fluid to 10% w/w. Optionally, the method further comprises M is sodium or potassium. Optionally, the method further comprises wherein the metal silicate is sodium metasilicate, sodium orthosilicate, potassium metasilicate, or potassium orthosilicate. Optionally, the method further comprises wherein the step of introducing the fracturing fluid into the subterranean formation comprises using a pump. Optionally, the method further comprises wherein the fracturing fluid is introduced into the subterranean formation at a pump flow rate of greater than or equal to 60 barrels per minute.

An embodiment of the present disclosure is a fracturing fluid comprising: a base fluid, wherein the base fluid comprises water; proppant; a friction reducer; and a metal silicate having a molar ratio of SiO₂:M₂O of 2:1 or above, wherein M is an alkali metal atom or an alkaline earth metal atom. Optionally, the fluid further comprises a base fluid having a total dissolved solids concentration in the range from 500 mg/L to 300,000 mg/L. Optionally, the fluid further comprises the friction reducer comprising a non-cross-linked polymer. Optionally, the fluid further comprises the non-cross-linked polymer selected from the group consisting of polyacrylamide, derivatives of polyacrylamide, copolymers of polyacrylamide, and combinations thereof. Optionally, the fluid further comprises the friction reducer in a concentration in the range of 0.1 gpt to 10 gpt. Optionally, the fluid further comprises the fracturing fluid further comprising a gelling agent, and wherein the gelling agent comprises a cross-linked polymer. Optionally, the fluid further comprises the cross-linked polymer selected from the group consisting of guar, guar gum derivatives, polysaccharides and derivatives, cellulose derivatives, and combinations thereof. Optionally, the fluid further comprises the fracturing fluid having a viscosity greater than 10 cP at a shear rate of 40 s⁻¹ and a temperature of 77° F. Optionally, the fluid further comprises the metal silicate in a concentration in the range of 0.01% weight by weight of the base fluid to 10% w/w. Optionally, the fluid further comprises M is sodium or potassium. Optionally, the fluid further comprises the metal silicate is sodium metasilicate, sodium orthosilicate, potassium metasilicate, or potassium orthosilicate.

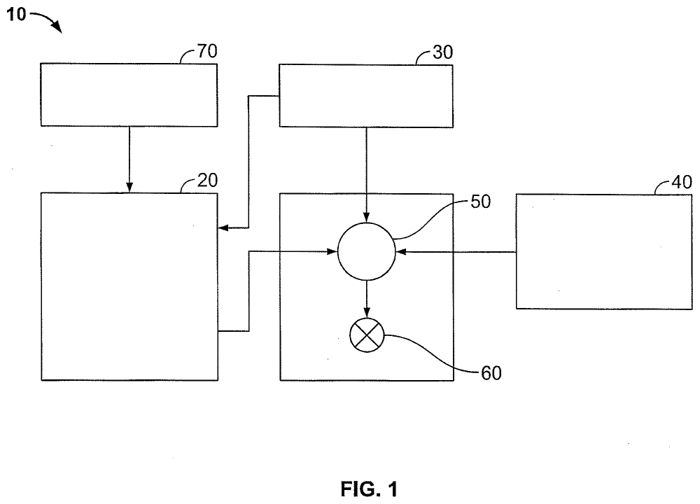

FIG. 1 depicts a well system that can be used according to embodiments of the present disclosure. A well system 10 of FIG. 1 can include a stimulation fluid producing apparatus 20, a fluid source 30, a proppant source 40, and a pump and blender system 50 and resides at the surface at a well site where a well 60 is located. In certain embodiments, the stimulation fluid producing apparatus 20 can combine additives with a fluid (e.g., liquid or substantially liquid) from fluid source 30, to produce a stimulation fluid that is used to stimulate a formation. The stimulation fluid can be a fluid for ready use in a stimulation treatment of the well 60 or a concentrate to which additional fluid is added prior to use in a stimulation treatment of the well 60. In other instances, the stimulation fluid producing apparatus 20 can be omitted and the stimulation fluid sourced directly from the fluid source 30.

The proppant source 40 can include a proppant for combining with a fracturing fluid or a fracturing acidizing fluid. The system may also include additive source 70 that provides one or more additives (e.g., metal silicates, friction reducers, surfactants, and/or other optional additives) to alter the properties of the stimulation fluid.

The pump and blender system 50 can receive the stimulation fluid and combine it with other components, including proppant from the proppant source 40 and/or additional additives from the additive source 70. The resulting mixture may be pumped into the well 60 under a pressure sufficient to create or enhance one or more fractures in a subterranean zone, for example, to stimulate production of fluids from the zone. The resulting mixture may also be pumped into the well 60 at a pressure less than the fracture pressure of the subterranean formation. The stimulation fluid producing apparatus 20, fluid source 30, and/or proppant source 40 can each be equipped with one or more metering devices (not shown) to control the flow of fluids, proppant, and/or other compositions to the pumping and blender system 50. Such metering devices may permit the pumping and the blender system 50 to pull from one, some, or all of the different sources at a given time, and may facilitate the preparation of stimulation fluids using continuous mixing or “on-the-fly” methods.

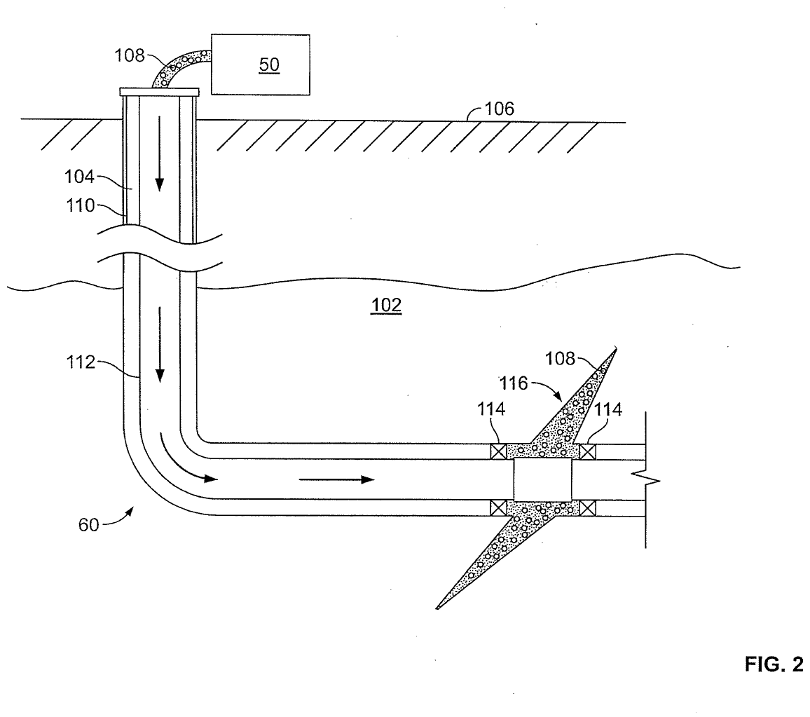

The step of introducing any of the stimulation fluids can comprise pumping the stimulation fluid into the subterranean formation. FIG. 2 shows the well 60 during a fracturing operation in a portion of a subterranean formation 102. The fracturing operation can be performed, for example, using the fracturing fluids or fracturing acidizing fluids. The subterranean formation can be penetrated by a well. The step of introducing can also include introducing any of the stimulation fluids into the well. The well includes a wellbore 104. The wellbore 104 extends from the surface 106, and the stimulation fluid 108 (e.g., a fracturing fluid) is introduced into a portion of the subterranean formation 102. The wellbore 104 can include a casing 110 that is cemented or otherwise secured to the wellbore wall. The wellbore 104 can be uncased or include uncased sections. Perforations can be formed in the casing 110 to allow stimulation fluids and/or other materials to flow into the subterranean formation 102. In cased wells, perforations can be formed using shaped charges, a perforating gun, hydro-jetting and/or other tools.

The well is shown with a work string 112. The pump and blender system 50 can be coupled to the work string 112 to pump the stimulation fluid 108 into the wellbore 104. The work string 112 can include coiled tubing, jointed pipe, and/or other structures that allow fluid to flow into the wellbore 104. The work string 112 can include flow control devices, bypass valves, ports, and or other tools or well devices that control a flow of fluid from the interior of the work string 112 into the subterranean formation 102. For example, the work string 112 can include ports (not shown) located adjacent to the wellbore wall to communicate the fracturing fluid 108 directly into the subterranean formation 102, and/or the work string 112 can include ports that are spaced apart from the wellbore wall to communicate the fracturing fluid 108 into an annulus that is located between the outside of the work string 112 and the wall of the wellbore.

The well system can include one or more sets of packers 114 that create one or more wellbore intervals. According to some embodiments, the methods also include creating or enhancing one or more fractures within the subterranean formation using the fracturing fluid or a fracturing acidizing fluid. When the fracturing or fracturing acidizing fluid is introduced into wellbore 104 (e.g., in FIG. 2, the wellbore interval located between the packers 114) at a sufficient hydraulic pressure, one or more fractures 116 may be created in the subterranean formation 102. The proppant particulates in the fracturing fluid or fracturing acidizing fluid may enter the fractures 116 where they may remain after the fluid flows out of the wellbore. The proppant can be placed into the one or more fractures during the step of introducing. The proppant can form a proppant pack within the one or more fractures.

### Examples

To facilitate a better understanding of the various embodiments, the following examples are given.

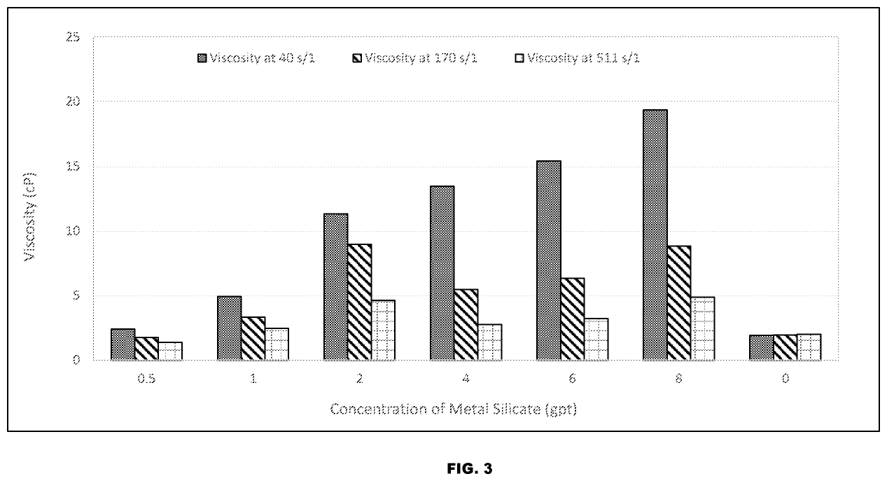

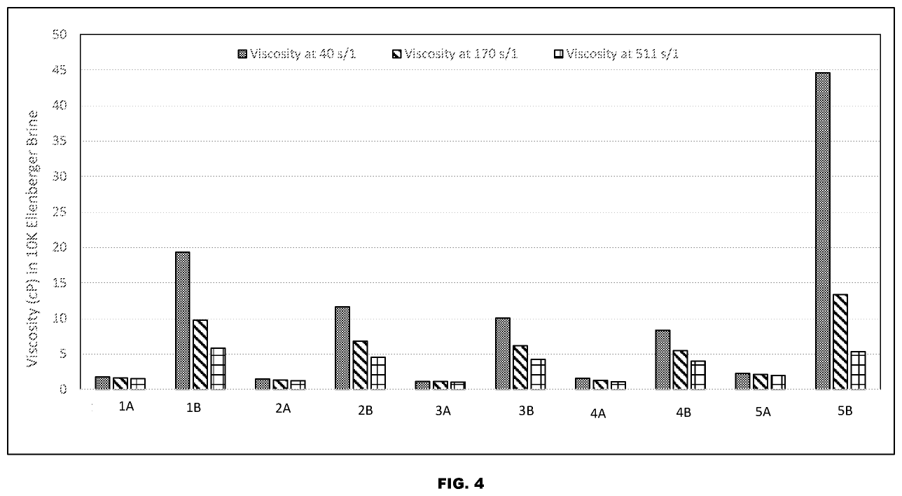

FIGS. 3 and 4 are bar graphs showing viscosity testing of various test fluids. Viscosity testing was performed using a Anton Paar Rheometer 702 by preparing various fluids and testing at a temperature of 77° F. (25° C.) using shear sweep and calculated shear rates of 40 S⁻¹, 170 s⁻¹, or 511 s⁻¹. The base fluid for the fluids contained water and a total dissolved solids concentration of 10,000 mg/L. The fluids for FIG. 3 included a polyacrylamide based friction reducer with a surfactant package at a concentration of 2 gallons per thousand gallons “gpt” of the base fluid and varying concentrations in units of gpt of a sodium metasilicate in liquid form (approximately 30% w/w). The fluids for FIG. 4 contained the base fluid and various non-cross-linked polyacrylamides at a concentration of either 1 gpt or 2 gpt. The friction reducers had unknown differences in molecular weight, homopolymers or possibly copolymers, but all contained polyacrylamide. The control fluids only contained the various friction reducers, while test fluids further included 8 gpt of a sodium metasilicate in liquid form (approximately 30% w/w), as shown in Table 1.

TABLE 1

| | Concentration | Concentration of |
|---|---|---|
| | of Friction | Metal Silicate |
| Fluid | Reducer (gpt) | (gpt) |
| 1A | 2 | 0 |
| 1B | 2 | 8 |
| 2A | 1 | 0 |
| 2B | 1 | 8 |
| 3A | 1 | 0 |
| 3B | 1 | 8 |
| 4A | 1 | 0 |
| 4B | 1 | 8 |
| 5A | 2 | 0 |
| 5B | 2 | 8 |

As can be seen in FIG. 3, with concentrations as low as 1 gpt of the metal silicate (at 30% w/w solubility in liquid form), the simulated slickwater fluid unexpectedly had a viscosity of 5 cP at a shear rate of 40 s⁻¹ compared to a viscosity of 2 cP for the control fluid without the metal silicate. As can also be seen, the viscosity of the control fluid at each of the three shear rates is almost identical; however, the addition of the metal silicate creates a synergistic effect with the friction reducer whereby variation in the viscosities at the three shear rates occurs. This indicates that not only can the addition of a metal silicate work cooperatively with a friction reducer to increase the viscosity of a fluid at a lower cost, but also the concentration of the metal silicate can be adjusted based in part on the desired pumping flow rate into a wellbore.

Different friction reducers were tested with and without the metal silicate as shown in FIG. 4. As can be seen, each of the control fluids containing only the friction reducer without the metal silicate had a viscosity of less than 5 cP at each shear rate. However, with the addition of the metal silicate, the vast majority of the fluids at the three shear rates unexpectedly achieved a viscosity of at least 5 cP. As can also be seen, the friction reducers in fluids 1B and 5B obtained the highest increase in viscosity at 40 s⁻¹ compared to the other friction reducers. This indicates that the type of friction reducer can be selected based on the desired viscosity of a treatment fluid.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the compositions, methods, and systems of the present disclosure are well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present disclosure.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more fluids, additives, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A method of fracturing a subterranean formation comprising:
introducing a fracturing fluid into the subterranean formation, wherein the fracturing fluid comprises:
a base fluid, wherein the base fluid comprises water;
proppant;
a friction reducer, wherein the friction reducer comprises a non-cross-linked polymer; and
a metal silicate having a molar ratio of SiO₂:M₂O of 2:1 or above, wherein M is an alkali metal atom or an alkaline earth metal atom; and
creating or enhancing one or more fractures in the subterranean formation.

2. The method according to claim 1, wherein the base fluid has a total dissolved solids concentration in the range from 500 mg/L to 300,000 mg/L.

3. (canceled)

4. The method according to claim 1, wherein the non-cross-linked polymer is selected from the group consisting of polyacrylamide, derivatives of polyacrylamide, copolymers of polyacrylamide, and combinations thereof.

5. The method according to claim 1, wherein the friction reducer is in a concentration in the range of 0.1 gpt to 10 gpt.

6. The method according to claim 1, wherein the fracturing fluid further comprises a gelling agent, and wherein the gelling agent comprises a cross-linked polymer.

7. The method according to claim 6, wherein the cross-linked polymer is selected from the group consisting of guar, guar gum derivatives, polysaccharides and derivatives, cellulose derivatives, and combinations thereof.

8. The method according to claim 1, wherein the fracturing fluid has a viscosity greater than 10 cP at a shear rate of 40 s⁻¹ and a temperature of 77° F.

9. The method according to claim 1, wherein the metal silicate is added to the base fluid in a liquid form, and wherein the metal silicate is in a concentration in the range of 0.01 to 20 gallons per thousand gallons of the base fluid.

10. The method according to claim 1, wherein the metal silicate is added to the base fluid in a dry, solid form, and wherein the metal silicate is in a concentration in the range of 0.01% weight by weight of the base fluid to 10% w/w.

11. The method according to claim 1, wherein M is sodium or potassium.

12. The method according to claim 12, wherein the metal silicate is sodium metasilicate, sodium orthosilicate, potassium metasilicate, or potassium orthosilicate.

13. The method according to claim 1, wherein the step of introducing the fracturing fluid into the subterranean formation comprises using a pump.

14. The method according to claim 13, wherein the fracturing fluid is introduced into the subterranean formation at a pump flow rate of greater than or equal to 60 barrels per minute.

15. A method of fracturing a subterranean formation comprising:
introducing a fracturing fluid into the subterranean formation, wherein the fracturing fluid comprises:
a base fluid, wherein the base fluid comprises water;
proppant;
a friction reducer, wherein the friction reducer comprises a non-cross-linked polyacrylamide; and
a metal silicate having a molar ratio of SiO₂:M₂O of 2:1 or above, wherein the metal silicate is sodium metasilicate, sodium orthosilicate, potassium metasilicate, or potassium orthosilicate; and
creating or enhancing one or more fractures in the subterranean formation.

16. A fracturing fluid comprising:
a base fluid, wherein the base fluid comprises water;
proppant;
a friction reducer, wherein the friction reducer comprises a non-cross-linked polymer; and
a metal silicate having a molar ratio of SiO₂:M₂O of 2:1 or above, wherein M is an alkali metal atom or an alkaline earth metal atom.

17. (canceled)

18. The fluid according to claim 16, wherein the fracturing fluid has a viscosity greater than 10 cP at a shear rate of 40 s⁻¹ and a temperature of 77° F.

19. The fluid according to claim 16, wherein the metal silicate is in a concentration in the range of 0.01% weight by weight of the base fluid to 10% w/w.

20. The fluid according to claim 16, wherein the metal silicate is sodium metasilicate, sodium orthosilicate, potassium metasilicate, or potassium orthosilicate.

21. The method according to claim 1, wherein the metal silicate is an alkaline metal silicate, and wherein the metal silicate has a molar ratio of SiO₂:M₂O in the range of 2:1 to 2.85:1.

22. The method according to claim 1, wherein the metal silicate is a neutral metal silicate, and wherein the metal silicate has a molar ratio of SiO₂:M₂O in the range of 2.85:1 to 3.75:1.
